(19) United States
(12) Patent Application Publication
(10) Pub. No.: US 2018/0024532 A1
(43) Pub. Date: Jan. 25, 2018

(54) METHODS AND SYSTEMS FOR EVALUATING A FITTING CONDITION OF TWO OR MORE ADJACENT SURFACES

(71) Applicant: Toyota Motor Engineering & Manufacturing North America, Inc., Erlanger, KY (US)

(72) Inventor: Aaron Burton, Fort Wright, KY (US)

(73) Assignee: Toyota Motor Engineering & Manufacturing North America, Inc., Erlanger, KY (US)

(21) Appl. No.: 15/215,167

(22) Filed: Jul. 20, 2016

(51) Int. Cl. G05B 19/4093; G05B 19/402

(52) U.S. Cl. CPC G05B 19/40931; G05B 19/402; H04N 2013/0074

(57) ABSTRACT

A method for evaluating a fitting condition of two or more adjacent surfaces includes scanning, with a scanner, a first surface, scanning, with the scanner, a second surface adjacent to the first surface, extrapolating, using one or more processors communicatively coupled to the scanner, a first extrapolated curvature of the first surface, extrapolating, using the one or more processors communicatively coupled to the scanner, a second extrapolated curvature of the second surface, determining a curvature continuity value by comparing the first extrapolated curvature with the second extrapolated curvature, wherein the curvature continuity value represents a degree of parallelism between the first extrapolated curvature and the second extrapolated curvature, and determining a fitting condition comprising at least comparing the curvature continuity value to a predetermined curvature continuity threshold.

### TECHNICAL FIELD

The present specification generally relates to methods and systems for evaluating fitting conditions and, more specifically, methods and systems for evaluating the fitting condition of two or more adjacent surfaces.

### BACKGROUND

Large gaps or varying curvature between two or more adjacent surfaces are visually unappealing to consumers. Current methods for evaluating a fitting condition between two or more parts do not generally consider the variance in curvature between the two or more surfaces. When the curvature of the part is not considered in determining a fitting condition, the parts may still appear to be ill-fitting with one another, even if the gap between the two or more surfaces is minimized.

Accordingly, a need exists for alternative methods and systems for evaluating the fitting condition of two or more adjacent surfaces.

### SUMMARY

In one embodiment, a method for evaluating a fitting condition of two or more adjacent surfaces includes scanning, with a scanner, a first surface, scanning with the scanner, a second surface adjacent to the first surface, extrapolating, using one or more processors communicatively coupled to the scanner, a first extrapolated curvature of the first surface, extrapolating, using the one or more processors communicatively coupled to the scanner, a second extrapolated curvature of the second surface, determining a curvature continuity value by comparing the first extrapolated curvature with the second extrapolated curvature, wherein the curvature continuity value represents a degree of parallelism between the first extrapolated curvature and the second extrapolated curvature, and determining a fitting condition comprising at least comparing the curvature continuity value to a predetermined curvature continuity threshold.

In another embodiment, a system for evaluating a fitting condition of two or more adjacent surfaces includes one or more processors, one or more scanners communicatively coupled to the one or more processors, and one or more memory modules communicatively coupled to the one or more processors. The one or more memory modules store logic that when actuated by the one or more processors causes the one or more processors to scan, with the one or more scanners, a first surface, scan, with the one or more scanners, a second surface adjacent to the first surface, extrapolate a first extrapolated curvature of the first surface, extrapolate a second extrapolated curvature of the second surface, extend the first extrapolated curvature toward the second extrapolated curvature, and compare the first extrapolated curvature and the second extrapolated curvature to determine a curvature continuity value, wherein the curvature continuity value represents a degree of parallelism between the first extrapolated curvature and the second extrapolated curvature.

In yet another embodiment, a method of evaluating a fitting condition of two or more adjacent surfaces includes scanning, with a three-dimensional scanner, a first surface, scanning, with the three-dimensional scanner, a second surface adjacent to the first surface, extrapolating a first extrapolated curvature of a first leading portion of the first surface, extrapolating a second extrapolated curvature of a second leading portion of the second surface, determining a curvature continuity value by comparing the first extrapolated curvature with the second extrapolated curvature, wherein the curvature continuity value represents a degree of parallelism between the first extrapolated curvature and the second extrapolated curvature, determining a fitting condition comprising at least comparing the curvature continuity value with a predetermined curvature continuity threshold, and adjusting one of the first surface and the second surface when the fitting condition is larger than a predetermined fitting condition threshold.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a schematic view of a system for evaluating a fitting condition of two or more adjacent surfaces, according to one or more embodiments shown and described herein;

FIG. 2 depicts a vehicle having two or more adjacent surfaces to be evaluated by the system of FIG. 1, according to one or more embodiments shown and described herein;

FIG. 3 depicts a schematic cross sectional view of two adjacent surfaces of the vehicle of FIG. 2, according to one or more embodiments shown and described herein;

FIG. 4 depicts a flow diagram of a method for evaluating a fitting condition of two or more adjacent surfaces, according to one or more embodiments shown and described herein;

FIG. 5 depicts a schematic cross-sectional view of the adjacent surfaces of FIG. 2 having extrapolated curvatures, wherein the exemplary curvatures of the adjacent surfaces intersect one another, according to one or more embodiments shown and described herein;

FIG. 6 depicts a schematic cross-sectional view of the adjacent surfaces of FIG. 2 having extrapolated curvatures, wherein the exemplary curvatures of the adjacent surfaces are parallel and offset from one another, according to one or more embodiments shown and described herein; and

FIG. 7 depicts a schematic cross-sectional view of the adjacent surfaces of FIG. 2 having extrapolated curvatures, wherein the exemplary curvatures of the adjacent surfaces coincide with one another, according to one or more embodiments shown and described herein.

### DETAILED DESCRIPTION

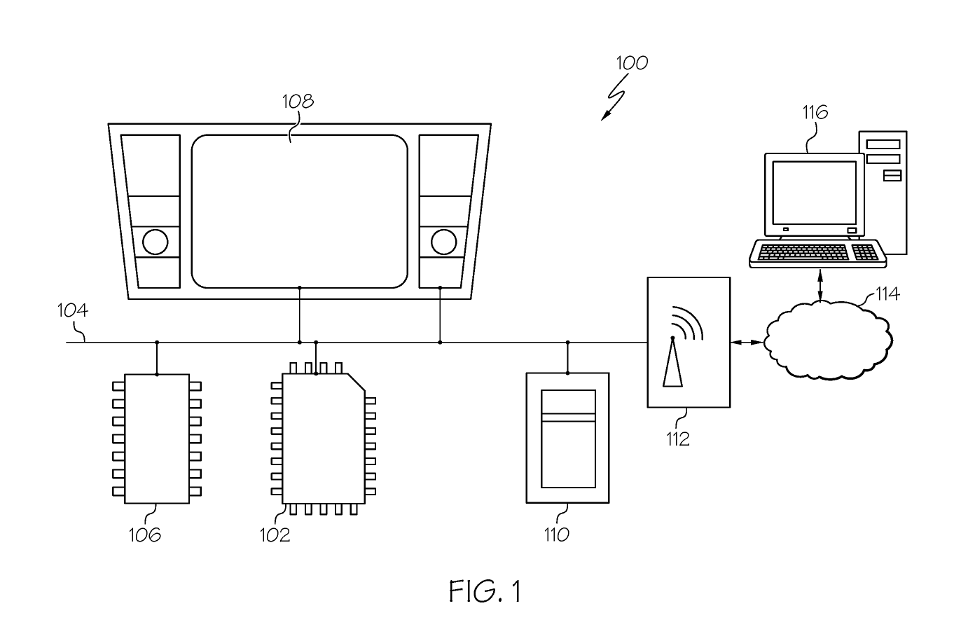

Embodiments disclosed herein include methods and systems for evaluating a fitting condition of two or more adjacent surfaces. Methods according to the present disclosure generally include scanning, with a scanner, two or more adjacent surfaces. From the data obtained from scanning the two or more adjacent surfaces, extrapolated curvatures may be extrapolated from the two or more adjacent surfaces. The extrapolated curvatures may then be compared to determine a fitting condition of the two or more adjacent surfaces. FIG. 1 generally depicts one embodiment of a system for carrying out the methods described herein and evaluating a fitting condition of the two or more adjacent surfaces. The system generally includes one or more processors, one or more memory modules, one or more displays, one or more scanners, network interface hardware, and a remote computing device. Various embodiments of the system and the methods of using the system will be described in more detail herein.

Referring now to FIG. 1, an embodiment of a system 100 for evaluating a fitting condition of two or more adjacent surfaces is schematically depicted. The system 100 includes one or more processors 102. Each of the one or more processors 102 may be any device capable of executing machine readable instructions. Accordingly, each of the one or more processors 102 may be a controller, an integrated circuit, a microchip, a computer, or any other computing device. The one or more processors 102 are communicatively coupled to a communication path 104 that provides signal interconnectivity between various modules. Accordingly, the communication path 104 may communicatively couple any number of processors 102 with one another, and allow the modules coupled to the communication path 104 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 104 may be formed from any medium that is capable of transmitting a signal such as, for example, conductive wires, conductive traces, optical waveguides, or the like. In some embodiments, the communication path 104 may facilitate the transmission of wireless signals, such as WiFi, Bluetooth, and the like. Moreover, the communication path 104 may be formed from a combination of mediums capable of transmitting signals. In one embodiment, the communication path 104 comprises a combination of conductive traces, conductive wires, connectors, and buses that cooperate to permit the transmission of electrical data signals to components such as processors, memories, sensors, input devices, output devices, and communication devices. Accordingly, the communication path 104 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

The system 100 further includes one or more memory modules 106 coupled to the communication path 104. The one or more memory modules 106 may comprise RAM, ROM, flash memories, hard drives, or any device capable of storing machine readable instructions such that the machine readable instructions can be accessed by the one or more processors 102. The machine readable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable instructions and stored on the one or more memory modules 106. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any suitable computer programming language, as pre-programmed hardware elements, or as a combination of hardware and software components.

In embodiments, the one or more memory modules 106 may include a variety of logic that when actuated by the one or more processors 102, causes the one or more processors 102 to perform a variety of functions. Some non-limiting examples of logic include scanning logic, point cloud generation logic, mesh generation logic, curvature extrapolation logic, and comparison logic. As will be described in more detail herein, the system 100 is configured to scan two or more adjacent surfaces, extrapolate a curvature of the two or more adjacent surfaces, and compare the two or more adjacent surfaces to determine a fitting condition.

The system 100, in some embodiments, further includes a display 108 communicatively coupled to the one or more processors 102 over the communication path 104. Accordingly, the communication path 104 communicatively couples the display 108 to other modules of the system 100. The display 108 may include any medium capable of transmitting an optical output such as, for example, a cathode ray tube, light emitting diodes, a liquid crystal display, a plasma display, or the like. Moreover, the display 108 may be a touch screen that, in addition to providing optical information, detects the presence and location of a tactile input upon a surface of or adjacent to the display 108. Accordingly, the display 108 may receive mechanical input directly upon the optical output provided by the display 108. Additionally, it is noted that the display 108 can include at least one of the one or more processors and the one or memory modules. In some embodiments, the display 108 may be integrated into a remote computing device 116.

The system 100 includes one or more scanners 110 communicatively coupled to the one or more processors 102. The one or more scanners 110 are configured to capture surface data from real-world surfaces, for example, surface contour data. In some embodiments, the one or more scanners 110 may comprise three-dimensional scanners, two-dimensional scanners, or a combination thereof. For example, and not as a limitation, the one or more scanners 110 may capture surface contour data from one or more surfaces of a vehicle (e.g. visible surfaces). The one or more scanners 110 generally capture surface contour data by scanning, with a sensor (e.g. an optical sensor, a laser, a radar array, or a LiDAR array) the targeted surfaces. From the surface contour data, the one or more processors 102 may execute point cloud logic to construct a point cloud from surface contour data, and using mesh generation logic, construct a surface contour model. Such systems and methods are further described in U.S. application Ser. No. 15/214,490 entitled “Systems and Methods for Aligning Measurement Data to Reference Data” and filed Jul. 20, 2016, hereby incorporated by reference. From this contour model, the one or more processors 102, or other computing devices, may execute curvature extrapolation logic to extrapolate a curvature from two or more surfaces. These extrapolated curvatures may be estimated from points along at least a portion of the surface contour model or the point cloud. For example, the extrapolated curvature may be based on a best fit curve applied to several points of the surface contour model or the point cloud.

In some embodiments, the system 100 comprises network interface hardware 112 for communicatively coupling the system 100 or individual modules of the system 100 to a remote computing device 116 such that data can be sent between components of the system 100 and the remote computing device 116. The network interface hardware 112 can be communicatively coupled to the communication path 104 and can be any device capable of transmitting and/or receiving data via a network 114. Accordingly, the network interface hardware 112 can include a communication transceiver for sending and/or receiving any wired or wireless communication. For example, the network interface hardware 112 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, the network interface hardware 112 includes hardware configured to operate in accordance with the Bluetooth wireless communication protocol. In another embodiment, network interface hardware 112 may include a Bluetooth send/receive module for sending and receiving Bluetooth communications to/from a mobile device 145. Some embodiments may not include the network interface hardware 112.

As such, the system 100 may be communicatively coupled to a remote computing device 116 via a network 114. In some embodiments, the network 114 is a personal area network that utilizes Bluetooth technology to communicatively couple components of the system 100, for example, the remote computing device 116. In other embodiments, the network 114 may include one or more computer networks (e.g., a personal area network, a local area network, or a wide area network), cellular networks, satellite networks and/or a global positioning system and combinations thereof. Accordingly, the system 100 can be communicatively coupled to the network 114 via the network interface hardware 112. Suitable local area networks may include wired Ethernet and/or wireless technologies such as, for example, wireless fidelity (Wi-Fi). Suitable personal area networks may include wireless technologies such as, for example, IrDA, Bluetooth, Wireless USB, Z-Wave, ZigBee, and/or other near field communication protocols. Suitable personal area networks may similarly include wired computer buses such as, for example, USB and FireWire. Suitable cellular networks include, but are not limited to, technologies such as LTE, WiMAX, UMTS, CDMA, and GSM.

As stated above, the network interface hardware 112 may be utilized to communicatively couple the system 100 to the remote computing device 116 over the network 114. The remote computing device 116 can comprise one or more processors and one or more memories. The one or more processors of the remote computing device 116 can execute logic to process surface contour data collected by the one or more scanners 110. For example, the remote computing device 116 can provide supplementary processing power, via relatively high powered processors, to the system 100. Additionally, the remote computing device 116 can provide supplementary data storage to the system 100. The remote computing device 116 may include any device capable of processing surface contour data such as, for example, a laptop, a desktop, a tablet, and the like. In some embodiments, there may be no remote computing device 116.

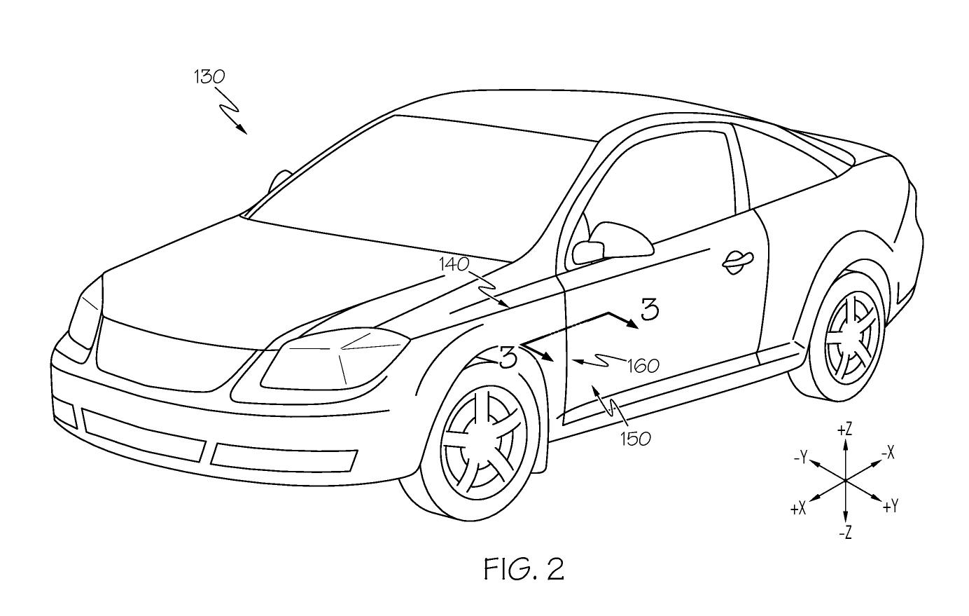

Referring now to FIG. 2, a vehicle 130 is depicted. The vehicle 130 has several class-A surfaces. Class-A surfaces refer to vehicle surfaces that are visually exposed. Though not depicted, class-A surfaces may also refer to visible surfaces within an interior of the vehicle 130. For example, and not as a limitation, vehicle class-A surfaces may include external, visible vehicle panels (e.g., hood, windshield, roof panel, front/back fender, door panel, etc.) or internal, visible vehicle surfaces (e.g., dashboard, console, etc.). It is noted that the present application is not limited to vehicle embodiments, and may be useful in other applications where visible surface continuity is desirable.

As used herein, the term “vehicle longitudinal direction” refers to the forward-rearward direction of the vehicle 130 (i.e., in the +/−vehicle X-direction as depicted). The term “vehicle lateral direction” refers to the cross-vehicle direction (i.e., in the +/−vehicle Y-direction as depicted), and is transverse to the vehicle longitudinal direction. The term “vehicle vertical direction” refers to the upward-downward direction of the vehicle 130 (i.e., in the +/−vehicle Z-direction as depicted).

By way of example, and not as a limitation, two vehicle surfaces are indicated for example embodiments described herein. A first surface 140 is generally illustrated as being a front fender panel. However, as noted herein, the first surface 140 could be any other visible surface of the vehicle 130. A second surface 150 is generally illustrated as being a door panel. However, as noted herein, the second surface 150 could be any other visible surface of the vehicle 130 that is adjacent to the first surface 140. For example, and not as a limitation, the first surface 140 may instead be a roof panel of the vehicle 130 while the second surface 150 is an A-pillar of the vehicle 130.

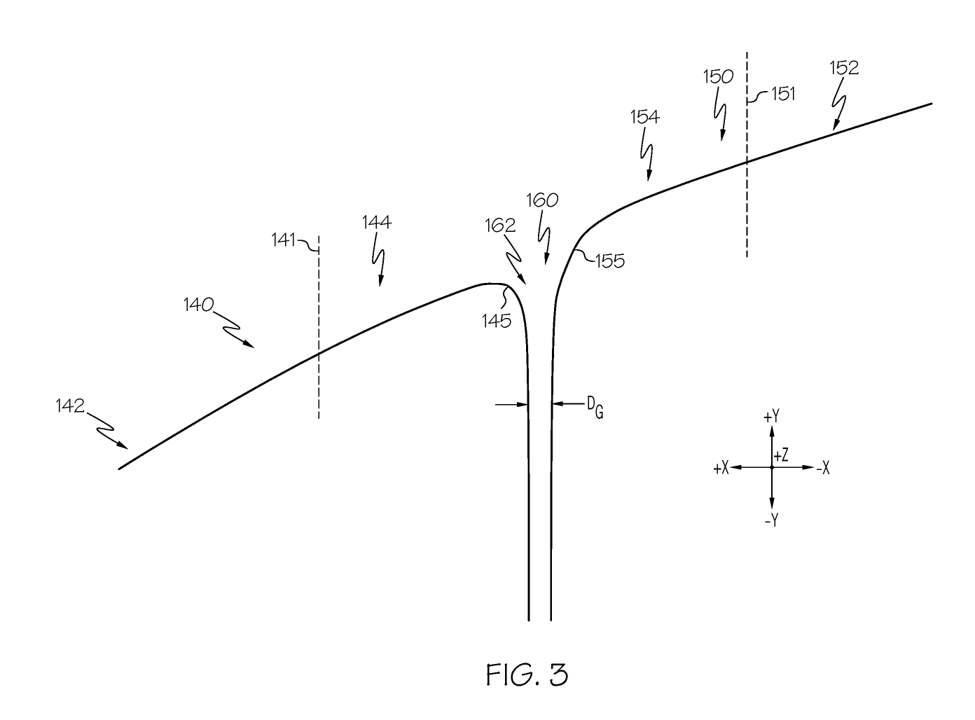

FIG. 3 generally shows a schematic cross-sectional view of the first surface 140 and the second surface 150 along line 3-3 in the vehicle lateral direction. The first surface 140 has a first leading portion 144 and a first trailing portion 142. A first dividing line 141 between the first leading portion 144 and the first trailing portion 142 is also illustrated. The second surface 150 has a second leading portion 154 and a second trailing portion 152. A second dividing line 151 between the second leading portion 154 and the second trailing portion 152 is also illustrated. As used herein, the term leading portion generally refers to the portion of the indicated surface that is closer to an interface 160 (also indicated in FIG. 2) between the first surface 140 and the second surface 150. As used herein, the term trailing portion generally refers to the portion of the indicated surface that is distal to the interface 160. In some embodiments the first leading portion 144 and the second leading portion 154 extend from the interface equal, or substantially equal, distances from the interface 160. The lengths of the first leading portion 144 and the second leading portion 154 may be a variety of lengths depending on different applications. By way of example and not as a limitation, the first leading portion 144 and the second leading portion 154 may extend from the interface 160 by about 0.5 cm to about 20 cm, for example, 1 cm, 2 cm, 3 cm, 5 cm, 10 cm, or the like. In other embodiments the first leading portion 144 may extend a shorter or further distance from the interface 160 than the second leading portion 154.

The first surface 140 and the second surface 150 may be separated by a horizontal gap 162 at the interface 160, having a distance D_{G} in the vehicle longitudinal direction. Generally, it is desirable to minimize the size of the gap 162, while still allowing for functional movement of surfaces that move (e.g., door panels, engine hoods, etc.). By providing a narrower gap 162 at the interface 160, the adjacent surfaces of the vehicle 130 may appear more seamless.

Referring still to FIG. 3, the first surface 140 has a first transition point 145. A transition point generally refers to the geometric center of the curve that transitions the first surface 140 from its visible surface to its non-visible surface that defines one side of the gap 162. The second surface 150 may similarly have a second transition point 155. The first transition point 145 and the second transition point 155 may be offset from one another in the vehicle lateral direction by a lateral offset. In some embodiments, it may be desirable to reduce this lateral offset to have a smoother transition. A large lateral offset may make the adjacent visible surfaces of the vehicle 130 appear non-continuous, and thus may be visually unappealing. However, it is noted that the lateral offset need not be zero. Furthermore, in some embodiments, a large lateral offset may not compromise the visual smoothness of the transition between the first and second surfaces 140, 150.

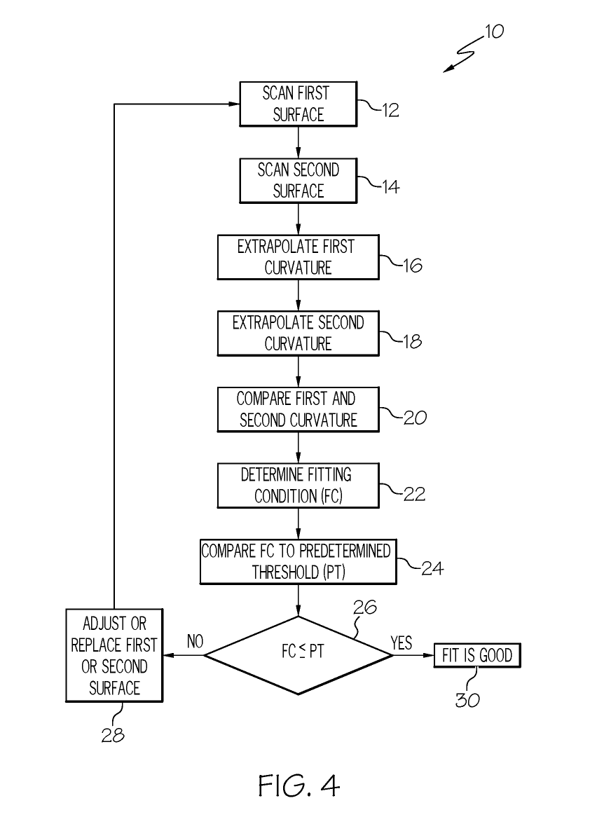

Referring now to FIG. 4 a flow chart 10 depicting a method for evaluating a fitting condition of two or more adjacent surfaces is illustrated. The flow chart 10 depicts a number of method steps illustrated by boxes 12-30. Though the method generally includes evaluating two surfaces, the method may evaluate more than two surfaces. For example, and not as a limitation, the method may evaluate three, four, or five adjacent surfaces.

Referring now the FIGS. 1, 3, and 4 together, at box 12, the first surface 140 of the vehicle 130 is scanned with the one or more scanners 110. At box 14, the second surface 150 is scanned with the one or more scanners 110. In some embodiments, the first surface 140 and the second surface 150 are scanned simultaneously. In other embodiments, the first surface 140 and the second surface 150 are scanned individually. By scanning the first and second surfaces 140, 150 with the one or more scanners 110, the system 100 collects surface contour data from the first and second surfaces 140, 150. It is noted that in some embodiments, the one or more processors 102 execute scanning logic to cause the one or more scanners 110 to scan the first and second surfaces 140, 150. In other embodiments, the first and second surfaces 140, 150 may be manually scanned with the one or more scanners 110.

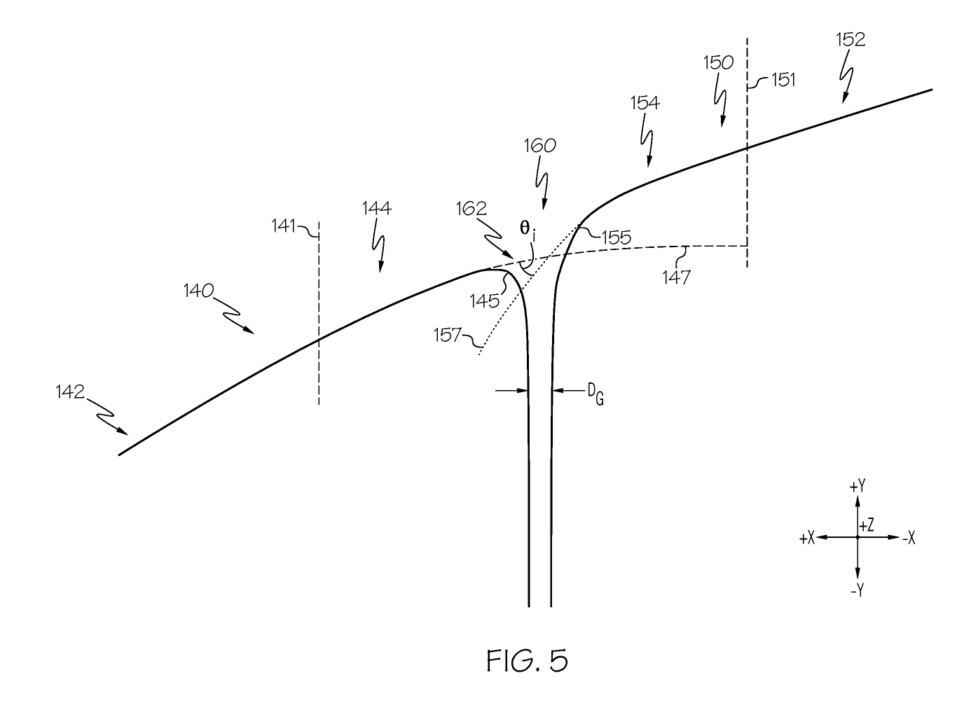

Referring also to FIG. 5, at box 16, based on the surface contour data collected by the one or more scanners 110, the one or more processors 102 may execute curvature extrapolation logic to extrapolate a first extrapolated curvature 147 of the first surface 140. Referring now to box 18, based on the surface contour data, the one or more processors 102 may execute curvature extrapolation logic to extrapolate a second extrapolated curvature 157 of the second surface 150. In other embodiments, the network interface hardware 112 may send the surface contour data over the network interface hardware 112 to the remote computing device 116, wherein the remote computing device 116 executes curvature extrapolation logic to extrapolate the first extrapolated curvature 147 and the second extrapolated curvature 157 from the surface contour data.

Referring now to FIGS. 1 and 5-7, the first extrapolated curvature 147 and the second extrapolated curvature 157 are each illustrated overlaying a cross-sectional view of the first surface 140 and the second surface 150. In some embodiments, the one or more processors 102 may execute logic stored on the one or more memory modules 106 to display 108 the first and second extrapolated curvatures 147, 157 on the display 108. The first and second extrapolated curvatures 147, 157 may be displayed relative to one another to correspond to positions of the first and second surfaces 140, 150. In some embodiments, the surface contour models or point clouds generated by the one or more processors 102 may also be displayed on the display 108.

The first surface 140 may not have a continuous curvature across its surface. As such, the first extrapolated curvature 147 may only be extrapolated from the leading portion 144 of the first surface 140, to focus the curvature analysis on the portion of the first and second surfaces 140, 150 closest to the interface 160 between the first and second surfaces 140, 150. This may be beneficial for analyzing and obtaining a smoother transition between the first surface 140 and the second surface 150 at the interface 160. A smoother transition may be obtained, for example, by adjusting the design of the first surface 140 and the second surface 150 based on this curvature analysis. However, it is contemplated that the extrapolated curvature may be extrapolated from any length of the first and second surfaces 140, 150, for example, the entire first and second surfaces 140, 150.

After the first and second extrapolated curvatures 147, 157 have been extrapolated from the surface contour data, referring to box 20 of FIG. 3, the first extrapolated curvature 147 may be compared to the second extrapolated curvature 157 when the one or more processors 102, or the remote computing device 116, executes comparison logic. Based on this comparison of the first extrapolated curvature 147 to the second extrapolated curvature 157, the system 100 may determine the fitting condition of the first surface 140 with the second surface 150.

There may be several ways to compare the first and second extrapolated curvatures 147, 157 to determine the fitting condition of the first and second surfaces 140, 150. For example, the one or more processors 102, or the remote computing device 116, may superimpose the first extrapolated curvature 147 over the second extrapolated curvature 157, or superimpose the second extrapolated curvature 157 over the first extrapolated curvature 147. In other embodiments, the one or more processors 102, or the remote computing device 116, may extend the first extrapolated curvature 147 toward the second extrapolated curvature 157. Further, the one or more processors 102, or the remote computing device 116 may extend the second extrapolated curvature 157 toward the first extrapolated curvature 147. Moreover, both the first extrapolated curvature 147 and the second extrapolated curvature 157 may be extended toward one another (such as shown in FIGS. 4-7). Based on the interaction of the first extrapolated curvature 147 and the second extrapolated curvature 157 when compared, factors relevant to the fitting condition of the first and second surfaces 140, 150, such as curvature continuity and curvature offset may be determined.

At box 22 of FIG. 3, and as indicated above, a fitting condition can be determined from the comparison of the first and second extrapolated curvatures 147, 157. A fitting condition generally refers to how well the first and second surfaces 140, 150 line up with one another such that there is a substantially seamless transition from one surface to the next. The first and second extrapolated curvatures 147, 157 allow for this fitting condition to be better quantified. For example, it may be desired that the first and second extrapolated curvatures 147, 157 are coincident along the gap 162 between the first and second surfaces 140, 150.

As described above, in determining the fitting condition, several factors may be taken into consideration. For example, the fitting condition may account for a curvature continuity value, a curvature offset value, or both. The curvature continuity value may be any value indicative of a degree of parallelism between the first and second extrapolated curvatures 147, 157. It is noted that the first and second extrapolated curvatures 147, 157 need not be parallel for their entire length of the first and second surfaces 140, 150, but a better visual fit may be accomplished when the first and second extrapolated curvatures 147, 157 are parallel at least through the first leading portion 144 and the second leading portion 154 of the first and second surfaces 140, 150.

In some embodiments, the curvature continuity value may be quantified by the value of the angle of intersection θᵢ of the first and second extrapolated curvatures 147, 157 when the first and second extrapolated curvatures 147, 157 are superimposed over one another or when the first and second extrapolated curvatures 147, 157 are extended toward one another. Referring also to FIG. 5, the first and second extrapolated curvatures 147, 157 are shown as being extended toward one another and having an angle of intersection θᵢ. It is contemplated that a high angle of intersection θᵢ between the first extrapolated curvature 147 the second extrapolated curvature 157 may indicate a lower degree of curvature continuity. It is also contemplated that a low angle of intersection θᵢ between the first extrapolated curvature 147 the second extrapolated curvature 157 may indicate a greater degree of curvature continuity, and thus lead to a better fitting condition.

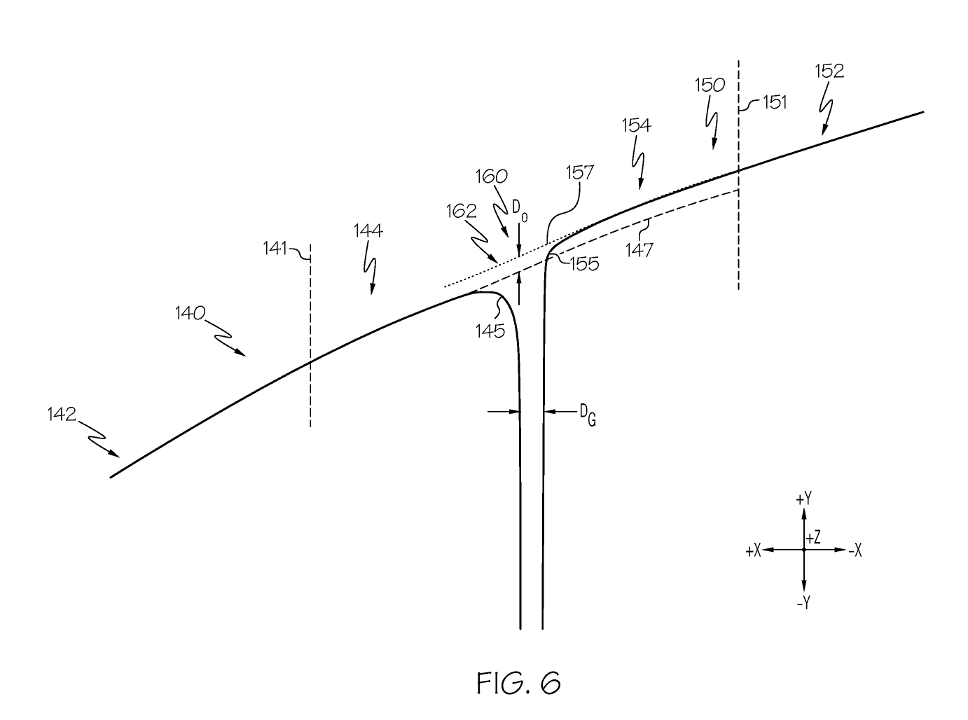

The curvature offset value may be any value indicative of the offset of the first and second extrapolated curvatures 147, 157 from one another. As a non-limiting example, the first and second extrapolated curvatures 147, 157 may be considered offset from one another when the first and second extrapolated curvatures 147, 157 do not cross or overlay one another when extended over the gap 162 as described herein. If the curvature offset value is large through the gap 162, the transition between the first and second surfaces 140, 150 may appear discontinuous. By way of example, FIG. 6 illustrates an example wherein the first and second extrapolated curvatures 147, 157 are offset from one another by an offset distance Dₒ. A large offset distance Dₒ is indicative of greater curvature offset value while a small offset distance Dₒ is indicative of a smaller curvature offset value. Further a smaller offset distance Dₒ is indicative of a better fitting condition. In some embodiments, the offset distance Dₒ may not be constant over the gap 162. In such case, the offset distance may be considered the greatest offset distance Dₒ over the gap 162. In other embodiments, the offset distance Dₒ may be considered the average offset distance Dₒ over the gap 162.

Referring again to FIG. 3, at box 24 the one or more processors 102, or the remote computing device 116, executes logic to compare the fitting condition to a predetermined threshold fitting condition. The predetermined threshold fitting condition comprises a predetermined curvature continuity threshold, a predetermined curvature offset threshold, or both. The curvature continuity value may be compared to the predetermined curvature continuity threshold. Similarly, the curvature offset value may be compared to a predetermined curvature offset threshold. The predetermined curvature continuity threshold may be a range of angles and the predetermined curvature offset threshold may be a range of distances. In some embodiments the predetermined threshold fitting condition may only include the predetermined curvature continuity threshold.

Referring to FIG. 5, as stated above, the predetermined curvature continuity threshold may be a range of angles (e.g., the angle of intersection θᵢ) that correspond to a “good” fitting condition. For example, and not as a limitation, the predetermined curvature continuity threshold may be less than or equal to an angle of intersection θᵢ of about 10°, such as about 8°, about 5°, about 3°, etc. In other embodiments, the predetermined curvature continuity threshold for a good fitting condition may be larger or smaller depending on the application.

Referring to FIG. 6, as stated above, the predetermined curvature offset threshold may be a range of distances that correspond to a “good” fitting condition. For example, and not as a limitation, the predetermined curvature offset threshold may be less than or equal to an offset distance, Dₒ, of 10 mm, such as about 8 mm, 5 mm, 3 mm, or the like. In other embodiments, the predetermined curvature offset threshold for a good fitting condition may be larger or smaller depending on the application.

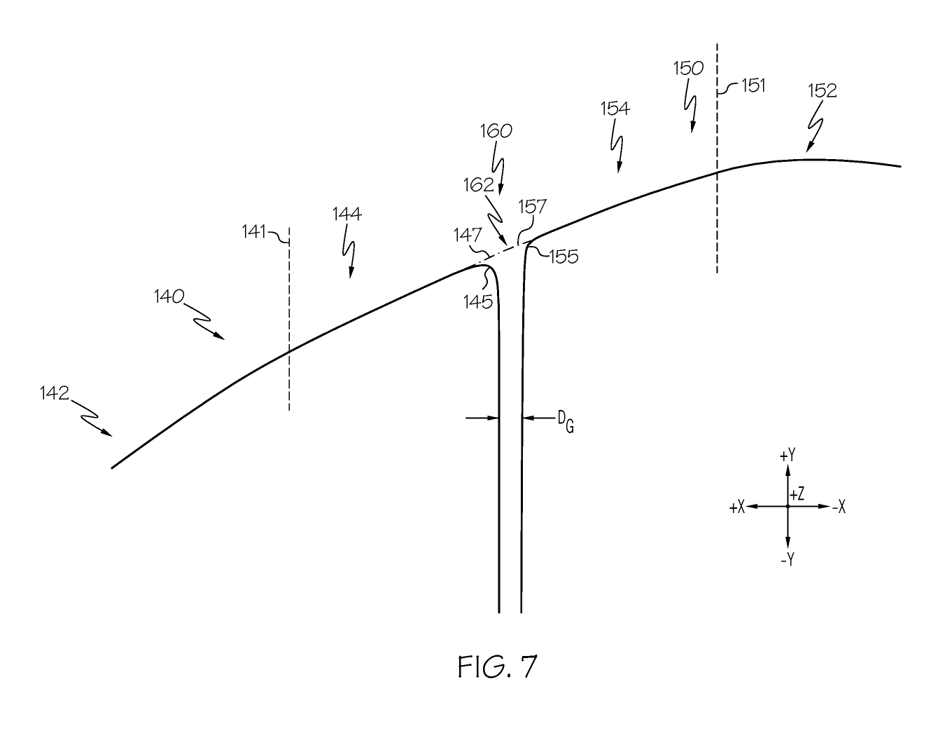

Referring now to box 26, if the one or more processors 102, or the remote computing device 116, determines that the fitting condition is smaller than or equal to the predetermined fitting condition, the fit of the first surface 140 and the second surface 150 is considered to be good (box 30). FIG. 7 indicates an example wherein there is a good fitting condition. As can be seen, there is no angle of intersection, θᵢ, and no offset distance, Dₒ. As such, the curvature continuity value would be less than the predetermined curvature continuity threshold and the curvature offset value would be less than the predetermined curvature offset threshold.

Referring to box 28 of FIG. 4, the one or more processors 102, or the remote computing device 116, may determine that the fitting condition is not smaller than the predetermined fitting condition (such as shown in FIGS. 5 and 6). In such a case, at least one of the first and second surfaces 140, 150 may be adjusted or replaced. The process may then be repeated to determine if the adjusted or replaced surface now has a good fitting condition relative to the adjacent surface(s).

It should now be understood the methods and systems described herein allow for a fitting condition between two or more adjacent surfaces to be determined beyond visual inspection. For example, where the two or more adjacent surfaces are ill fitted to one another, but are visually flush, it may be difficult to determine what aspect of the adjacent surfaces are preventing the adjacent surfaces from having a visually appealing transition. Methods and systems as described herein use curvature continuity values, curvature offset values, or both to determine the fitting condition of the two or more adjacent surfaces. By comparing the fitting condition of the two or more adjacent surfaces to a predetermined fitting condition threshold, the characteristics causing the two or more adjacent surfaces to be ill-fitted with one another may be determined. For example, a curvature continuity value may be found to be larger than the predetermined curvature continuity threshold, and/or a curvature offset value may be larger than the predetermined curvature offset threshold. Based on the characteristics, the two or more adjacent panels may be adjusted or redesigned such that the curvature continuity value and/or the curvature offset value are within the predetermined thresholds. Thus, smoother transitions between adjacent surfaces may be achieved.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method of evaluating a fitting condition of two or more adjacent surfaces, the method comprising:
scanning, with a scanner, a first surface;
scanning, with the scanner, a second surface adjacent to the first surface;
extrapolating, using one or more processors communicatively coupled to the scanner, a first extrapolated curvature of the first surface;
extrapolating, using the one or more processors communicatively coupled to the scanner, a second extrapolated curvature of the second surface;
determining a curvature continuity value by comparing the first extrapolated curvature with the second extrapolated curvature, wherein the curvature continuity value represents a degree of parallelism between the first extrapolated curvature and the second extrapolated curvature; and
determining a fitting condition of the first surface and the second surface comprising at least comparing the curvature continuity value to a predetermined curvature continuity threshold.

2. The method of claim 1, further comprising superimposing the first extrapolated curvature over the second extrapolated curvature to compare the first extrapolated curvature with the second extrapolated curvature.

3. The method of claim 1, further comprising extending the first extrapolated curvature toward the second extrapolated curvature.

4. The method of claim 1, further comprising extending the second extrapolated curvature toward the first extrapolated curvature.

5. The method of claim 1, wherein the scanner comprises a three-dimensional scanner.

6. The method of claim 1, further comprising determining a curvature offset value between the first extrapolated curvature and the second extrapolated curvature, wherein the curvature offset value represents an offset distance Dₒ between the first extrapolated curvature and the second extrapolated curvature over a gap between the first surface and the second surface.

7. The method of claim 6, wherein determining the fitting condition further comprises comparing the curvature offset value to a predetermined curvature offset threshold.

8. A system for evaluating a fitting condition of two or more adjacent surfaces, the system comprising:
one or more processors;
one or more scanners communicatively coupled to the one or more processors; and
one or more memory modules communicatively coupled to the one or more processors that store logic that when actuated by the one or more processors causes the one or more processors to:
scan, with the one or more scanners, a first surface;
scan, with the one or more scanners, a second surface adjacent to the first surface;
extrapolate a first extrapolated curvature of the first surface;
extrapolate a second extrapolated curvature of the second surface;
extend the first extrapolated curvature toward the second extrapolated curvature; and
compare the first extrapolated curvature and the second extrapolated curvature to determine a curvature continuity value, wherein the curvature continuity value represents a degree of parallelism between the first extrapolated curvature and the second extrapolated curvature.

9. The system of claim 8, wherein the one or more processors extend the second extrapolated curvature toward the first extrapolated curvature.

10. The system of claim 8, further comprising a display communicatively coupled to the one or more processors, wherein:
the first extrapolated curvature is displayed on the display; and
the second extrapolated curvature is displayed on the display.

11. The system of claim 8, wherein the curvature continuity value is equal to an angle of intersection θᵢ of the first extrapolated curvature and the second extrapolated curvature.

12. The system of claim 8, wherein the one or more processors further determine a fitting condition at least by comparing the curvature continuity value to a predetermined curvature continuity threshold.

13. The system of claim 8, wherein the one or more processors further determines a curvature offset value between the first extrapolated curvature and the second extrapolated curvature, wherein the curvature offset value represents an offset distance Dₒ between the first extrapolated curvature and the second extrapolated curvature over a gap between the first surface and the second surface.

14. The system of claim 13, wherein the one or more processors determine a fitting condition by comparing:
the curvature continuity value with a predetermined curvature continuity threshold; and
the curvature offset value to a predetermined curvature offset threshold.

15. The system of claim 8, wherein the first extrapolated curvature of the first surface is extrapolated from a first leading portion of the first surface.

16. The system of claim 8, wherein the second extrapolated curvature of the second surface is extrapolated from a second leading portion of the second surface.

17. A method of evaluating a fitting condition of two or more adjacent surfaces, the method comprising:
scanning, with a three-dimensional scanner, a first surface;
scanning, with the three-dimensional scanner, a second surface adjacent to the first surface;
extrapolating a first extrapolated curvature of a first leading portion of the first surface;
extrapolating a second extrapolated curvature of a second leading portion of the second surface;
determining a curvature continuity value by comparing the first extrapolated curvature with the second extrapolated curvature, wherein the curvature continuity value represents a degree of parallelism between the first extrapolated curvature and the second extrapolated curvature;
determining a fitting condition comprising at least comparing the curvature continuity value with a predetermined curvature continuity threshold; and
adjusting one of the first surface and the second surface when the fitting condition is larger than a predetermined fitting condition threshold.

18. The method of claim 17, further comprising determining a curvature offset value between the first extrapolated curvature and the second extrapolated curvature, wherein the curvature offset value represents an offset distance Dₒ between the first extrapolated curvature and the second extrapolated curvature over a gap between the first surface and the second surface.

19. The method of claim 18, wherein determining the fitting condition further comprises comparing the curvature offset value to a predetermined curvature offset threshold.

20. The method of claim 17, further comprising displaying the first extrapolated curvature and the second extrapolated curvature on a display.
